(19) United States
(12) Patent Application Publication
(10) Pub. No.: US 2008/0123215 A1
(43) Pub. Date: May 29, 2008

(54) PROCESS FOR PRODUCING HARD DISK DEVICE, PROCESS FOR ADJUSTING FLYING HEIGHT OF MAGNETIC HEAD, AND HARD DISK DEVICE

(75) Inventors: Toshihiko Yoshikawa, Ichihara-shi (JP); Yoshihito Sueoka, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/945,619

(22) Filed: Nov. 27, 2007

(30) Foreign Application Priority Data
Nov. 29, 2006 (JP) 2006-321595

(51) Int. Cl. G11B 21/02

(52) U.S. Cl. 360/75

(57) ABSTRACT

A process for producing a hard disk device which is capable of producing a hard disk device having an excellent electromagnetic conversion characteristic at a high yield, and a process for adjusting flying height of a magnetic head having excellent reliability which is capable of improving the electromagnetic conversion characteristic of a hard disk device and preventing damage of a magnetic head derived from contact between a magnetic recording medium and a magnetic head are provided. Such a process for producing a hard disk device having a magnetic recording medium and a head gimbal assembly 20 having a magnetic head 3 which is arranged opposed to the magnetic recording medium to record and reproduce information includes an adjusting step of adjusting the flying height using an adjusting mechanism which adjusts the flying height of the magnetic head 3 to the magnetic recording medium while detecting the contact between the magnetic recording medium and the magnetic head 3 using a sensor 2 which is installed to the head gimbal assembly 20.

### BACKGROUND OF THE INVENTION

1. Field of the Invention

The present invention relates to a process for producing a hard disk device, a process for adjusting the flying height of a magnetic head, and a hard disk device, in particular, to a process for producing a hard disk device which is capable of producing a hard disk device having excellent electromagnetic conversion characteristics at a high yield, and a process for adjusting the flying height of a magnetic head having excellent reliability which is capable of improving electromagnetic conversion characteristics of a hard disk device and preventing damage of a magnetic head derived from contact between a magnetic recording medium and a magnetic head.

Priority is claimed on Japanese Patent Application No. 2006-321595, filed Nov. 29, 2006, the content of which is incorporated herein by reference.

2. Description of Related Art

At present, the recording density of a hard disk device (hard disk drive) has reached 150 G bits/square inch, and it is said that increasing recording density at 30% per year will continue further from now on.

For this reason, technological development for increasing recording density of a hard disk device has proceeded.

In general, in a hard disk device, a magnetic head is opposed to a magnetic recording medium, and the magnetic recording medium is rotated at a high speed to allow the magnetic head to run at a high speed above a surface of the recording medium, thereby floating the magnetic head utilizing air flow which is generated between the magnetic head and the magnetic recording medium. A magnetic recording medium usually has a disk shape, and the number of revolutions at this time is equal to 15,000 rpm.

In addition, a magnetic head is installed to a head slider so as to be floated from the surface of the magnetic recording medium at the time of recording or reproducing in the hard disk device. The head slider is attached to an end of a suspension arm of a head gimbal assembly.

As for the head gimbal assembly, air flow generated upon rotating the magnetic recording medium flows under the magnetic head to bend a suspension arm, thereby floating the magnetic head with respect to the magnetic recording medium (for example, Patent Document 1 (Japanese Unexamined Patent Application, First Publication No. 4-366408)).

In a hard disk device having such a head gimbal assembly, the flying height of the magnetic head to the magnetic recording medium tends to decrease as the density of a hard disk device increases, and at present, the flying height has reached 10 nm or less, which is an ultimate value.

Electromagnetic conversion characteristics such as the SN ratio of a magnetic recording medium can be increased by reducing the flying height of the magnetic head to the magnetic recording medium.

As a method for reducing the flying height of a magnetic head, a method of applying an electrical voltage to a piezoelectric element which is installed to a magnetic head of a head gimbal assembly to deform the shape of the piezoelectric element, thereby reducing the distance between the magnetic head and the magnetic recording medium has been proposed (for example, Patent Document 2(Japanese Unexamined Patent Application, First Publication No. 2005-078754)).

In addition, a method which includes thermally expanding a magnetic head by heating the magnetic head to push the magnetic head out in the direction of a floating face, thereby reducing the flying height between the magnetic head and the magnetic recording medium only at the time of a writing or a reading operation has been proposed (for example, Patent Document 3(Japanese Unexamined Patent Application, First Publication No. 2003-168274)).

However, the conventional technology is not capable of sufficiently reducing the flying height of the magnetic head and sufficiently preventing damage of the magnetic head due to contact between the magnetic recording medium and the magnetic head, and as a result, a production process which is capable of controlling the flying height of a magnetic head more accurately and improving the yield further is demanded.

For example, in the case in which the flying height of a magnetic head is adjusted using a head gimbal assembly disclosed in Patent Document 2, it is necessary to detect the moment when the magnetic head comes into contact with the magnetic recording medium in order to reduce the flying height as much as possible. As a method for detecting the moment, there is a method which includes detecting the sound which is generated when a magnetic head comes into contact with a magnetic recording medium outside the hard disk device.

However, in this method, it is difficult to install a mechanism for detecting sound to the hard disk device, and as a result, this method has been applied only at a laboratory level.

In addition, as a method for detecting the moment when a magnetic head comes into contact with a magnetic recording medium, there is a method which detects electric signals output from the magnetic head when the magnetic head comes into contact with the magnetic recording medium.

However, electrical signals output from the magnetic head in this method are those obtained by calculation depending on the Wallace formula that there is no change in the distance of the magnetic head due to the contact between the magnetic head and the magnetic recording medium or by an air bearing vibration of the magnetic head, and there is a problem in that the sensitivity of the signal is low and the dispersion due to the magnetic head is large.

For this reason, there were many cases in which the magnetic head was damaged in the process of adjusting the distance between the magnetic head and the magnetic recording medium in the method of detecting electrical signals output from the magnetic head.

The present invention was made in view of the above problems, and it is an object of the present invention to provide a process for producing a hard disk device which is capable of producing a hard disk device at a high yield, because it is possible to control the flying height of a magnetic head accurately to reduce the flying height of the magnetic head sufficiently, and it is possible to prevent the damage of the magnetic head due to contact between the magnetic head and the magnetic recording medium, sufficiently.

In addition, it is another object of the present invention to provide a process for adjusting the flying height of a magnetic head which is capable of controlling the flying height of a magnetic head accurately, thereby reducing the flying height of a magnetic head and preventing damage of a magnetic head due to contact between a magnetic head and a magnetic recording medium, and a hard disk device.

### SUMMARY OF THE INVENTION

The inventors of the present invention have thoroughly researched in order to solve the above problems, and as a result, they have found that the above problems can be solved by installing a sensor for detecting contact between the magnetic recording medium and the magnetic head to a head gimbal assembly having a magnetic head and adjusting the flying height while detecting the contact between the magnetic recording medium and the magnetic head by the sensor, thereby completing the present invention. That is, the present invention is as follows.

[1] A process for producing a hard disk device having a magnetic recording medium and a head gimbal assembly having a magnetic head which is arranged opposed to the magnetic recording medium to record and reproduce information, which comprises an adjusting step of adjusting the flying height using an adjusting mechanism which adjusts the flying height of the magnetic head to the magnetic recording medium while detecting contact between the magnetic recording medium and the magnetic head using a sensor which is installed to the head gimbal assembly.
[2] The process for producing a hard disk device as set forth in [1], in which the adjusting step includes a step of rotating the magnetic recording medium to float the magnetic head, a step of reducing the flying height using the adjusting mechanism while detecting the contact between the magnetic recording medium and the magnetic head by the sensor, a step of outputting a detecting signal to the sensor when detecting the contact between the magnetic recording medium and the magnetic head, and a step of varying the applied electrical voltage to the adjusting mechanism using the detecting signal output from the sensor to remove the magnetic recording head from the magnetic recording medium through the adjusting mechanism, thereby adjusting the flying height to a predetermined value.

### [3] The process for producing a hard disk device as set forth in [1] or [2], in which the sensor is installed to a head slider or a suspension arm of the head gimbal assembly.

### [4] The process for producing a hard disk device as set forth in any one of [1] to [3], in which the adjusting mechanism is a piezoelectric element and/or a heater which expands or shrinks the head slider by heat to adjust the flying height.

### [5] The process for producing a hard disk device as set forth in any one of [1] to [4], in which the sensor is an actuator which is installed to the head gimbal assembly for moving the magnetic head to the magnetic recording medium.

[6] A process for adjusting a flying height of a magnetic head to a magnetic recording medium of a hard disk device having a magnetic recording medium, a head gimbal assembly having a magnetic head which is arranged opposed to the magnetic recording medium to record and reproduce information, a sensor which is installed to the head gimbal assembly to detect contact between the magnetic recording medium and the magnetic head, and an adjusting mechanism which adjusts the flying height of the magnetic sensor to the magnetic recording medium, which includes an adjusting step of adjusting the flying height using the adjusting mechanism while detecting the contact between the magnetic recording medium and the magnetic head using the sensor.
[7] A hard disk device including a magnetic recording medium, a head gimbal assembly having a magnetic head which is arranged opposed to the magnetic recording medium to record and reproduce information, a sensor which is installed to the head gimbal assembly to detect contact between the magnetic recording medium and the magnetic head, an adjusting mechanism which adjusts the flying height of the magnetic sensor to the magnetic recording medium, and a function of adjusting the flying height using the adjusting mechanism while detecting the contact between the magnetic recording medium and the magnetic head using the sensor.

### [8] The hard disk device as set forth in [7], in which the sensor is installed to the head slider or the suspension arm of the head gimbal assembly.

### [9] The hard disk device as set forth in [7] or [8], in which the adjusting mechanism is a piezoelectric element and/or a heater which expands or shrinks the head slider by heat to adjust the flying height.

### [10] The hard disk device as set forth in any one of [7] to [9], in which the sensor is an actuator which is installed to the head gimbal assembly for moving the magnetic head to the magnetic recording medium.

### BRIEF DESCRIPTION OF THE DRAWINGS

FIG. 1 is a diagonal view for explaining an example of hard disk device of the present invention produced by the process for producing a hard disk device of the present invention.

FIG. 2 is an enlarged diagonal view which shows a partially enlarged portion of the hard disk device shown in FIG. 1 and a schematic view of the head gimbal assembly which is seen from the magnetic recording medium side.

FIG. 3 is an enlarged cross-sectional view of the hard disk device shown in FIG. 1 showing a partially enlarged portion of the hard disk device.

FIG. 4 is a graph showing output changes in signals from a piezoelectric element.

### DETAILED DESCRIPTION OF THE INVENTION

An explanation will be given with respect to an embodiment of a process for producing a hard disk device of the present invention, a hard disk device, and a process for adjusting the flying height of a magnetic head of the present invention, referring to the drawings appropriately, below.

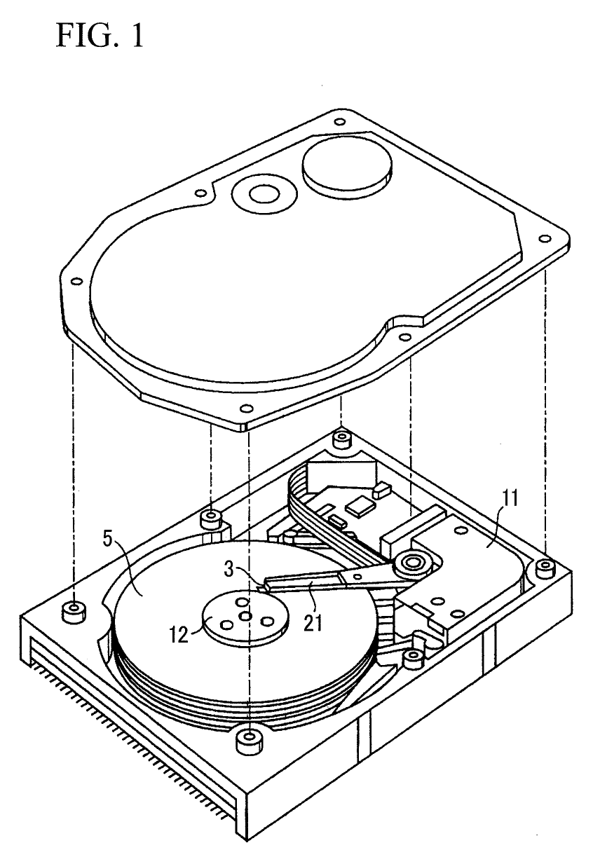

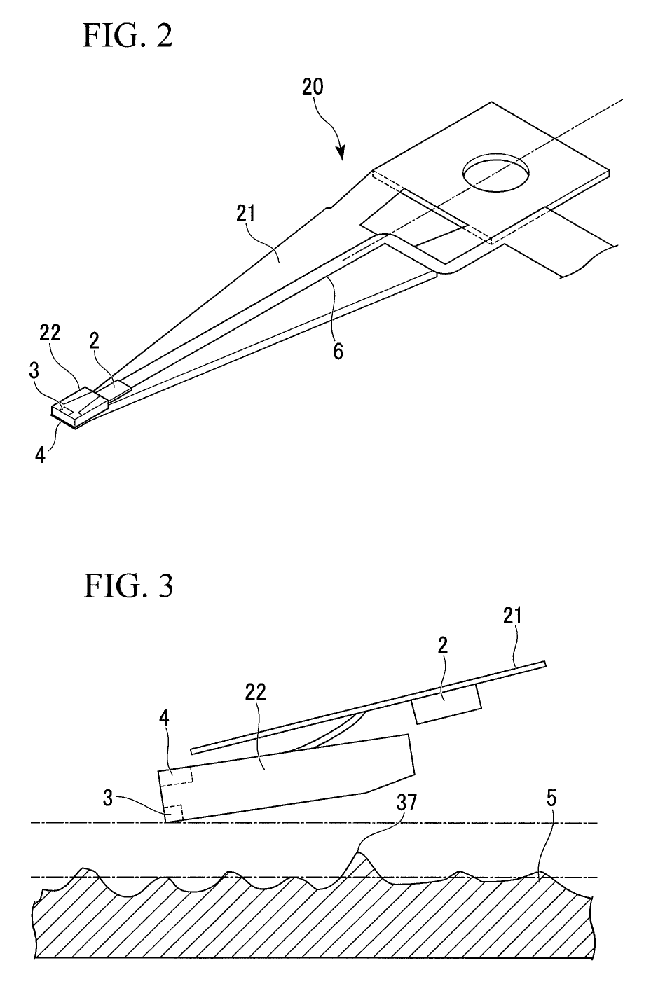

FIG. 1 is a diagonal view for explaining an example of a hard disk device of the present invention produced by the process for producing a hard disk device of the present invention. FIG. 2 is an enlarged diagonal view which shows a partially enlarged portion of the hard disk device shown in FIG. 1 and a schematic view of the head gimbal assembly which is seen from the magnetic recording medium side. FIG. 3 is an enlarged cross-sectional view of the hard disk device shown in FIG. 1 showing a partially enlarged portion of the hard disk device.

The hard disk device shown in FIG. 1 is equipped with a magnetic recording medium 5, a head gimbal assembly 20 having a magnetic head 3 which is facing a magnetic recording medium 5 to record and reproduce information, a medium driving part 12 which drives and rotates the magnetic recording medium 5, a head moving part 11 which moves the magnetic head 3 relative to the magnetic recording medium 5, and a recording and reproducing signal processing system.

The recording and reproducing signal processing system processes data input from the outside to send recorded signals to the head 3, and processes reproduced signals from the magnetic head 3 to send data outside.

The head gimbal assembly 20 is, as shown in FIG. 2, equipped with a suspension arm 21 which is made of a metal thin plate, a head slider 22 which is installed to a tip end side of the suspension arm 21, a magnetic head 3 which is installed onto the head slider 22, a sensor 2 which detects contact between the magnetic recording medium 5 and the magnetic head 3, a heater 4, and a controlling means which is connected to both the sensor 2 and the heater 4 through a signal line 6 (not shown in the drawings).

The magnetic head 3 is disposed to a portion close to the magnetic recording medium 5 in a trading side which is opposed to a reading side where a slope of the head slider 22 is formed. As the magnetic head 3, a head which is suitable for high recording density, having a TMR element which utilizes TMR, i.e. Tunnel-type Magneto Resistive, as a reproducing element, in addition to a MR (magneto resistance) element which utilizes GMR, i.e. Giant Magneto Resistive, can be used. In addition, it becomes possible to perform further high-density recording by using the TMR element.

The heater 4 is disposed to a portion on the side apart from the magnetic recording medium 5 (opposite side to the magnetic head 3) in the trading side of the head slider 22.

The heater 4 expands the head slider 22 by heat and shrinks the head slider 22 by decreasing the supplying amount of heat or stopping the supply of heat to change the shape of the head slider 22, thereby projecting the magnetic head 3 or reducing the projected amount of the magnetic head 3, and the heater 4 adjusts the flying height of the magnetic head 3 to the magnetic recording medium 5 by varying the applied electrical voltage.

The control means controls the applied electrical voltage to the heater 4, corresponding to detected signals output from the sensor 2. As the control means, those having a displaying apparatus which displays change in output of signals from the sensor 2 by imputing signals output from the sensor 2 thereto through the signal line 6, can be used. Specifically, a spectrum analyzer is preferably used.

As the sensor 2, an actuator which is installed to the head slider 22 in order to move minutely the magnetic head 3 to the magnetic recording medium 5 can be used.

As mentioned above, in this embodiment, a head driving part 11 which moves the magnetic head 3 relative to the magnetic recording medium 5 is disposed to the hard disk device shown in FIG. 1. In addition, in this embodiment, it is constituted such that the magnetic head 3 can be minutely moved to the magnetic recording medium 5 by an actuator which doubles as the sensor 2 being disposed to the head slider 22 of the head gimbal assembly 20, together with the head driving part 11 shown in FIG. 1. As the actuator used here, those which can move the magnetic head 3 accurately can be used, in addition, in the case in which it is used as a sensor, a piezoelectric element which can accurately detect the contact between the magnetic head 3 and the magnetic recording medium 5 is preferably used.

That is, an actuator which doubles as the sensor 2 is used in order to move the magnetic head 3 upon using the hard disk device, whereas the actuator is used in order to detect the contact between the magnetic head 3 and the magnetic recording medium 5 upon both producing the hard disk device and adjusting the flying height of the magnetic head 3.

Specifically, upon using the hard disk device, an electrical signal is applied to an actuator which doubles as the sensor 2 so as to serve as an actuator to move minutely the magnetic head 3 relative to the magnetic recording medium 5. And upon both producing the hard disk device and adjusting the flying height of the magnetic head 3, an actuator which doubles as the sensor 2 is used in order not to move the magnetic head 3, but to detect the contact between the magnetic recording medium 5 and the magnetic head 3 as the sensor 2 by monitoring the changing state in signals output as a result of imputing signals output from the actuator into the control means.

Thus, it becomes unnecessary to dispose a sensor to the head gimbal assembly for detecting the contact between the magnetic recording medium 5 and the magnetic head 3, thereby enabling a hard disk device to be produced at a low cost in accordance with the present invention.

In order to produce the hard disk device shown in FIG. 1, at first, a magnetic layer is formed onto a non-magnetic substrate to produce a magnetic recording medium 5.

Next, the flying height of the magnetic head 3 to the magnetic recording medium 5 is adjusted (adjusting step).

In this embodiment, at first, the magnetic recording medium 5 is rotated to float the magnetic head 3. The rotation rate of the magnetic recording medium 5 may range from 5,000 to 20,000 rpm, for example.

Subsequently, the contact between the magnetic recording medium 5 and the magnetic head 3 is detected by the sensor 2 to allow the sensor 2 to output signals, and then the signals are input to a control means through a signal line 6. And, while allowing a displaying apparatus of the control means to display an image of change in output of signals from the sensor 2, a head slider 22 is expanded with heat from the heater 4 to allow the magnetic head 3 to project, thereby reducing the flying height.

As shown in FIG. 3, the contact between the magnetic recording medium 5 and the magnetic head 3 begins at the highest portion of unevenness formed on the surface of the magnetic recording medium 5 (mark 37 in FIG. 3). Therefore, the contact surface between the magnetic recording medium 5 and the magnetic head 3 can be reduced by sensitively detecting the contact between the magnetic recording medium 5 and the magnetic head 3, thereby minimizing the damage of the magnetic head 3 accompanying the contact between the magnetic recording medium 5 and the magnetic head 3.

And, if a minute contact between the magnetic recording medium 5 and the magnetic head 3 is detected by the sensor 2, then a detective signal is output from the sensor 2 and input to the control means through the signal line 6. In this embodiment, if a detective signal is input to the control means, then the detective signal is displayed on the displaying apparatus of the control means and the applied electrical voltage to the heater 4 is controlled by the control means. Specifically, the applied electrical voltage to the heater 4 is varied by the control means to reduce or stop the supplied amount of heat from the heater 4, thereby reducing the projected amount of the magnetic head 3 which has been projected.

Thus, the magnetic head 3 is removed from the magnetic recording medium 5, thereby adjusting the flying height to a predetermined value. In this way, the production of a hard disk device is completed to obtain the hard disk device of which the flying height is adjusted to a predetermined value, shown in FIG. 1.

The process for producing a hard disk device of this embodiment includes the adjusting step of adjusting the flying height by the heater 4, while detecting the contact between the magnetic recording medium 5 and the magnetic head 3 using the sensor 2 which is installed to the head gimbal assembly 20, and hence it is possible to control the flying height accurately and prevent sufficiently the damage of the magnetic head 3 due to the contact between the magnetic recording medium 5 and the magnetic head 3, thereby reducing the damage of the magnetic head 3 due to the contact between the magnetic recording medium 5 and the magnetic head 3. Therefore, it is possible to produce a hard disk device at a high yield, having a low flying height of the magnetic head 3, a high truck density, and an excellent electromagnetic conversion characteristic, in accordance with the production process in this embodiment.

In this embodiment, the sensor 2 is installed to the head slider 22, and hence it becomes possible to detect sensitively the moment when the magnetic head 3 comes into contact with the magnetic recording medium 5, and as a result, the above effect can be obtained by the contact between the magnetic recording medium 5 and the magnetic head 3 being able to be detected with a very high sensitivity. In addition, the flying height is adjusted using the heater 4 in the process for producing a hard disk device of this embodiment, and hence the flying height can be minutely adjusted with a high accuracy.

It should be noted that, in the above embodiment, an explanation is given referring to the case in which, as the adjusting mechanism, the heater 4 is used to adjust the flying height by expanding and shrinking the head slider 22 with heat, however, the present invention is not limited to the above embodiment, any adjusting mechanism which is capable of adjusting the flying height of the magnetic head 3 to the magnetic recording medium can be used. For example, as the adjusting mechanism, a piezoelectric element and another mechanism which can adjust the flying height of the magnetic head 3 to the magnetic recording medium 5 by varying the applied electrical voltage may be used for or together with the heater 4. The flying height can be also minutely adjusted accurately in the case in which a piezoelectric element is used as the adjusting mechanism.

In addition, in the above embodiment, an explanation is given referring to the case in which an actuator which is disposed to the head slider 22 for moving the magnetic head 3 to the magnetic recording medium 5 is used as the sensor 2, however, the present invention is not limited to the above embodiment, that is, any sensor which can be installed to the head gimbal assembly 20 to detect the contact between the magnetic recording medium 5 and the magnetic head 3 may be used. For example, the sensor may be an actuator which can move the magnetic head 3, which is installed to the suspension arm 21, to the magnetic recording medium 5. Even in the case in which such a sensor 2 is used, it is possible to detect sensitively the contact between the magnetic recording medium 5 and the magnetic head 3, thereby reducing the damage of the magnetic head due to the contact between the magnetic recording medium 5 and the magnetic head 3.

In addition, in the above embodiment, the adjusting step is performed only once at the end of the production of a hard disk device, however, the adjusting step may be performed one or more times either during the production of the hard disk device or at the end of the production.

In addition, the adjusting step in the hard disk device of the present invention can be also used as a process for adjusting the flying height of the magnetic head of the present invention, by performing it after the production of the hard disk device It should be noted that the process for adjusting the flying height of the magnetic head of the present invention may be performed at any time after the production of the hard disk device, for example, it may be performed at regular intervals after the production of the hard disk device, or during the usage of the hard disk device.

Moreover, the adjusting step in the hard disk device of the present invention may be used in order to suppress the damage of the magnetic head due to the contact between a magnetic disk and the magnetic head by, for example, retracting the magnetic head when the magnetic head comes into contact with the magnetic disk, while monitoring the contact between the magnetic disk and the magnetic head upon using the hard disk device.

In addition, it is possible to constitute a hard disk device of the present invention from the sensor 2 which is installed to the head gimbal assembly 20 for detecting the magnetic recording medium 5 and the magnetic head 3, and the adjusting mechanism for adjusting the flying height of the magnetic head 3 to the magnetic recording medium 5, which is capable of performing the adjusting step at regular intervals and/or during the usage. In accordance with the hard disk device of the present invention, the flying height of the magnetic head can be sufficiently reduced, and the damage of the magnetic head due to the contact between the magnetic recording medium and the magnetic head can be sufficiently prevented.

### EXAMPLES

Next, an explanation in more detail will be given about the present invention, referring to experimental examples.

### Example 1

A hard disk device having a magnetic recording medium shown below, and a head gimbal assembly shown in FIG. 1 having a magnetic head shown below was produced, and the following adjusting step of the flying height of the magnetic head was performed after the production of the hard disk device.

### (Magnetic Head)

A GMR head made by Alps Electric Co., Ltd. was used.

### (Magnetic Recording Medium)

A magnetic layer was formed on a non-magnetic substrate to produce a magnetic recording medium. An amorphous glass substrate made by Hoya Co., Ltd. was used as the non-magnetic substrate. The size of the substrate was 65 mm in outer diameter, 25 mm in inner diameter, and 1.270 mm in thickness. A textured substrate was sufficiently washed and dried, and thereafter the resultant substrate was set in a chamber of a DC magnetron sputtering apparatus (Model: C3010 made by ANELVA Co., Ltd. (Japan)). And, until the degree of vacuum in the chamber became 2×10⁻⁷ Torr (2.7×10⁻⁵ Pa), the chamber was evacuated, and a non-magnetic grounding layer was laminated 6 nm in thickness onto the substrate using a target consisting of a Cr—Mn alloy (Cr: 70 at %, Mn: 30 at %). Subsequently, a magnetic layer 17 nm in thickness of a Co—Cr—Pt—B alloy layer was formed onto the non-magnetic grounding layer using a target consisting of a Co—Cr—Pt—B alloy (Co: 60 at %, Cr: 20 at %, Pt: 13 at %, B: 7 at %), and a protective film 3 nm in thickness consisting of carbon was formed onto the magnetic layer. It should be noted that the pressure of Ar at the time of film forming was 3 mTorr (0.4 Pa). Thereafter, a lubricant 2 nm in thickness consisting of perfluoropolyether was applied onto the protective film by a dipping method to form a liquid lubricant layer to obtain a magnetic recording medium.

### (Adjusting Step)

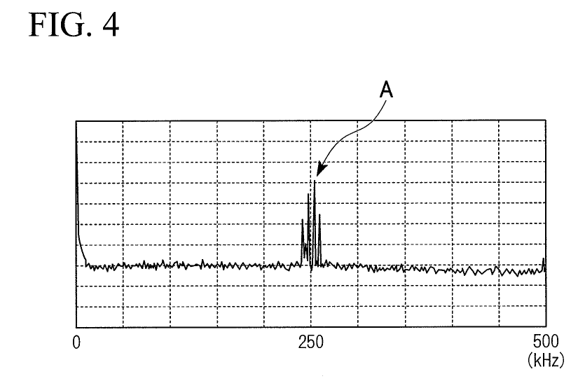

At first the magnetic recording medium 5 was rotated at 7,200 rpm to float the magnetic head 3. Subsequently, the contact between the magnetic recording medium 5 and the magnetic head 3 was detected through the sensor 2 consisting of a piezoelectric element which was installed to the head slider 22 of the head gimbal assembly 20 doubling as a micro actuator for moving the magnetic head 3 to the magnetic recording medium 5, to allow the sensor 2 to output signals, and the resultant signals were input to a spectrum analyzer (Model: 4396B made by Hewlett-Packard Co., Ltd.) as a control means through the signal line 6. And, as shown in FIG. 4, while displaying the change in output of signals from the piezoelectric element on the displaying apparatus of the spectrum analyzer, the head slider 22 was expanded by heating it using the heater 4 to allow the magnetic head 3 to project, thereby reducing the flying height.

And, until the signal shown in FIG. 4 is output from the sensor 2, the applied electrical voltage was increased, thereby confirming the touch-down between the magnetic recording medium 5 and the magnetic head 3. Thereafter, the applied electrical voltage to the heater 4 was slightly decreased to adjust the distance between the magnetic recording medium 5 and the magnetic head 3 (flying height) to be 5 nm.

Here, FIG. 4 is a graph showing output signals from the piezoelectric element, in which the horizontal axis shows frequency, and the vertical axis shows signal intensity (an arbitrary value). As shown by mark “A” in FIG. 4, a signal of 250 kHz showing the contact between the magnetic head and the magnetic recording medium was output from the piezoelectric element installed to the head slider 22.

### Comparative Example 1

A hard disk device having the same magnetic recording medium as in Example 1, and a head gimbal assembly shown in FIG. 1 which is equipped with the same magnetic head as in Example 1 was produced, and an adjusting step of the flying height of the magnetic head shown below was performed after the production.

### (Adjusting Step)

At first, the magnetic recording medium 5 was rotated similar to Example 1 to float the magnetic head 3, and the head slider 22 was expanded by the heater 4 similar to Example 1 to allow the magnetic head 3 project, thereby reducing the flying height. And the electric signal which was output when the magnetic head came into contact with the magnetic recording medium was detected, using the Wallace formula.

And, after the contact between the magnetic recording medium 5 and the magnetic head 3 was detected, the flying height was adjusted to be 5 nm by removing the magnetic head 3 from the magnetic recording medium 5, similar to Example 1.

### Comparative Example 2

A hard disk device having the same magnetic recording medium as in Example 1, and a head gimbal assembly shown in FIG. 1 which is equipped with the same magnetic head as in Example 1 was produced, and an adjusting step of the flying height of the magnetic head shown below was performed after the production.

### (Adjusting Step)

At first, the magnetic recording medium 5 was rotated similar to Example 1 to float the magnetic head 3, and the head slider 22 was expanded by the heater 4 similar to Example 1 to allow the magnetic head 3 to project, thereby reducing the flying height. And the electric signal which was output when the magnetic head came into contact with the magnetic recording medium was detected, through the air bearing vibration of the magnetic head.

And, after the contact between the magnetic recording medium 5 and the magnetic head 3 was detected, the flying height was adjusted to be 5 nm by removing the magnetic head 3 from the magnetic recording medium 5, similar to Example 1.

These adjusting steps of Example 1, Comparative Examples 1 and 2 were repeated 100 times, respectively, and as a result, the adjusting of the flying height of the magnetic head was completed.

And further, after the adjusting steps of Example 1, Comparative Examples 1 and 2 were performed, respectively, each of the heads which was used was replaced with a new one, and then the adjusting steps were performed similar to the above. Thereafter, each of the magnetic heads used was replaced with a new magnetic head similar to the above, and the adjusting step was performed using 10 magnetic heads in total for each of Example 1, and Comparative Examples 1 and 2, similar to the above.

Thereafter, the influence of the adjusting steps to the magnetic head in Example 1 and Comparative Examples 1 and 2 in the above was examined. That is, change in the recording and the reproducing signals of the magnetic head before and after the adjusting step in the above was examined, and if there was not at least 10% change in the recording and there producing signals before and after the adjusting step was performed it is judged that the magnetic head was damaged.

And as a result, when the flying height of the magnetic head was adjusted by the adjusting step of Example 1, all 10 piece magnetic heads used had not been damaged. In addition, in the adjusting step of Example 1, it was possible to detect the contact with respect to all 10 magnetic heads.

In contrast, when the flying height of the magnetic head was adjusted by the adjusting step of Comparative Example 1, 5 of the 10 magnetic heads used had been damaged. In addition, when the flying height of the magnetic head was adjusted by the adjusting step of Comparative Example 2, it was not possible to detect the contact with respect to 3 of the 10 magnetic heads. Moreover, in the adjusting step of Comparative Example 2, the sensitivity in detecting the contact was low, and the magnetic heads were excessively in contact with the magnetic recording medium, and as a result, all 10 magnetic heads were broken.

The process for producing a hard disk device of the present invention includes the adjusting step of adjusting the flying height using the adjusting mechanism, while detecting the contact between the magnetic recording medium and the magnetic head using the sensor which is installed to the head gimbal assembly, and hence it is possible to control the flying height accurately and sufficiently prevent the damage of the magnetic head due to the contact between the magnetic recording medium and the magnetic head. Therefore, it is possible to produce a hard disk device at a high yield, having a low flying height of the magnetic head, a high truck density, and an excellent electromagnetic conversion characteristic, in accordance with the production process of the present invention.

In addition, the process for adjusting the flying height of a magnetic head of the present invention includes the adjusting step of adjusting the flying height using the adjusting mechanism, while detecting the contact between the magnetic recording medium and the magnetic head using the sensor, and hence it is possible to control the flying height accurately and sufficiently prevent the damage of the magnetic head due to the contact between the magnetic recording medium and the magnetic head. Therefore, it serves as a process for adjusting a magnetic head which is capable of improving the electromagnetic conversion characteristic of a hard disk device, having excellent reliability.

In addition, the hard disk device of the present invention includes the function of adjusting the flying height using the adjusting mechanism, while detecting the contact between the magnetic recording medium and the magnetic head using the sensor, and hence, it is possible to control the flying height of the magnetic head accurately and sufficiently prevent the damage of the magnetic head due to the contact between the magnetic head and the magnetic recording medium.

Since the process for producing a hard disk device, the hard disk device, and the process for adjusting the flying height of the magnetic head of the present invention cause little damage to the magnetic head, and can adjust the distance between the magnetic head and the magnetic recording medium accurately, it is possible to increase productivity of the hard disk device, provide a product having high reliability, and hence the industrial utility value thereof is high.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A process for producing a hard disk device having a magnetic recording medium and a head gimbal assembly having a magnetic head which is arranged opposed to the magnetic recording medium to record and reproduce information, which comprises an adjusting step of adjusting the flying height using an adjusting mechanism which adjusts the flying height of the magnetic head to the magnetic recording medium while detecting contact between the magnetic recording medium and the magnetic head using a sensor which is installed to the head gimbal assembly.

2. The process for producing a hard disk device as set forth in claim 1, wherein the adjusting step comprises a step of rotating the magnetic recording medium to float the magnetic head, a step of reducing the flying height using the adjusting mechanism while detecting the contact between the magnetic recording medium and the magnetic head by the sensor, a step of outputting a detecting signal to the sensor when detecting the contact between the magnetic recording medium and the magnetic head, and a step of varying the applied electrical voltage to the adjusting mechanism using the detecting signal output from the sensor to remove the magnetic recording head from the magnetic recording medium through the adjusting mechanism, thereby adjusting the flying height to a predetermined value.

3. The process for producing a hard disk device as set forth in claim 1, wherein the sensor is installed to a head slider or a suspension arm of the head gimbal assembly.

4. The process for producing a hard disk device as set forth in claim 1, wherein the adjusting mechanism is a piezoelectric element and/or a heater which expands or shrinks the head slider by heat to adjust the flying height.

5. The process for producing a hard disk device as set forth in claim 1, wherein the sensor is an actuator which is installed to the head gimbal assembly for moving the magnetic head to the magnetic recording medium.

6. A process for adjusting a flying height of a magnetic head to a magnetic recording medium of a hard disk device having a magnetic recording medium, a head gimbal assembly having a magnetic head which is arranged opposed to the magnetic recording medium to record and reproduce information, a sensor which is installed to the head gimbal assembly to detect the contact between the magnetic recording medium and the magnetic head, and an adjusting mechanism which adjusts the flying height of the magnetic sensor to the magnetic recording medium, which comprises an adjusting step of adjusting the flying height using the adjusting mechanism while detecting the contact between the magnetic recording medium and the magnetic head using the sensor.

7. A hard disk device comprising: a magnetic recording medium, a head gimbal assembly having a magnetic head which is arranged opposed to the magnetic recording medium to record and reproduce information, a sensor which is installed to the head gimbal assembly to detect contact between the magnetic recording medium and the magnetic head, an adjusting mechanism which adjusts the flying height of the magnetic sensor to the magnetic recording medium, and a function of adjusting the flying height using the adjusting mechanism while detecting the contact between the magnetic recording medium and the magnetic head using the sensor.

8. The hard disk device as set forth in claim 7, wherein the sensor is installed to the head slider or the suspension arm of the head gimbal assembly.

9. The hard disk device as set forth in claim 7, wherein the adjusting mechanism is a piezoelectric element and/or a heater which expands or shrinks the head slider by heat to adjust the flying height.

10. The hard disk device as set forth in claim 7, wherein the sensor is an actuator which is installed to the head gimbal assembly for moving the magnetic head to the magnetic recording medium.
